(19) United States
(12) Patent Application Publication
(10) Pub. No.: US 2026/0222215 A1
(43) Pub. Date: Jul. 30, 2026

(54) Customer Specific Endpoint Upgrade Images for FIDO Device Onboarding (FDO)

(71) Applicant: Dell Products L.P., Round Rock, TX (US)

(72) Inventors: Mahesh Babu Ramaiah, Bangalore (IN); Joseph B. Caisse, Burlington, MA (US); Bradley K. Goodman, Nashua, NH (US); Ranjith Shanbhag, Bangalore (IN); Harsh Khatore, Ranchi (IN)

(73) Assignee: Dell Products L.P., Round Rock, TX (US)

(21) Appl. No.: 19/041,920

(22) Filed: Jan. 30, 2025

(51) Int. Cl. H04L 9/32; G06F 8/65; H04L 9/08

(52) U.S. Cl. CPC H04L 9/3236; G06F 8/65; H04L 9/0825; H04L 9/3247

(57) ABSTRACT

A process for managing customer-specific endpoint upgrade images for FIDO Device Onboarding (FDO) systems is disclosed. This approach addresses the problem of securely delivering customized software updates to edge devices and ensuring that updates are applied only to intended devices to maintain confidentiality and compatibility. The solution involves embedding customer signatures into upgrade images that are verified using a customer public verification method and a hash generation algorithm stored on the device. This enhances security and reliability by restricting updates to specific customer devices, thereby preventing unauthorized access and potential operational issues. The endpoint device includes a processor and memory that execute instructions to verify the customer signature and allow or block upgrades based on hash matching.

### BACKGROUND

As the value and use of information continues to increase, individuals and businesses seek additional ways to process and store information. One option is an Information Handling System (IHS). An IHS generally processes, compiles, stores, or communicates information or data for business, personal, or other purposes. Technology and information handling needs and requirements can vary between different applications. Thus, IHSs can also vary regarding what information is handled, how the information is handled, how much information is processed, stored, or communicated, and how quickly and efficiently the information can be processed, stored, or communicated. The variations in IHSs allow systems to be general or configured for a specific user or specific use such as financial transaction processing, airline reservations, enterprise data storage, internet of things (IOT) monitoring and communications, or global communications. In addition, IHSs can include a variety of hardware and software resources that can be configured to process, store, and communicate information and can include one or more computer systems, graphics interface systems, data storage systems, and networking systems. IHSs can also implement various virtualized architectures. Data communications among information handling systems may be via networks that are wired, wireless, optical or some combination.

IHSs can be used in a distributed environment as edge devices. Example edge devices include applications running in a retail store, such as point of sale device, a gateway, a compute or storage device not operating in a datacenter, remote industrial sensor and monitoring equipment, or deployed telecommunications equipment. The edge devices may require a significant number of customizations that are tailored to individual customer needs. These customizations may involve specific modifications that diverge from the edge device's core features. The modifications or “delta changes” typically need to be restricted to the requesting customers rather than included in a general release to all similar edge devices deployed for other customers. Further, edge devices may be vulnerable to attack due to being in a remote location and/or a lack of physical security and, therefore, any upgrades need to be secured to protect devices from malicious attacks.

### SUMMARY

Embodiments are directed to defining a model to establish guidelines for creating customer-specific upgrade images. This ensures that if an image is accessed by an unauthorized recipient, such as an edge device installed by another customer, then the update will fail to install on that unauthorized device. This mechanism ensures the confidentiality of customizations and also prevents issues that may arise due to variations in various customers'hardware and environments. This approach enhances security and reliability by containing any upgrades, patches, or hotfixes within the specific contexts and devices to which they were meant to be applied.

The embodiments herein disclose an FDO ownership-voucher-based guardrail model for verifying customer specific images that are carrying hotfixes, patches, or plugins. A mechanism is disclosed to create customer-specific endpoint images by embedding customer signatures into upgrade images as part of image pipeline.

### BRIEF DESCRIPTION OF THE DRAWINGS

Having thus described the invention in general terms, reference will now be made to the accompanying drawings, which are not necessarily drawn to scale, and wherein:

FIG. 1 is a high level block diagram illustrating a process for onboarding a device at a customer location using FDO.

FIG. 2 is a high level block diagram illustrating a process for generating a customer-specific device upgrade image.

FIG. 3 is flowchart illustrating a process for updating a device, such as an endpoint device or an edge device, using customer-specific upgrade images.

FIG. 4 shows an example of an Information Handling System (IHS) configured to implement systems and methods as described herein for creating FDO-based customer-specific endpoint upgrade images.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

The Fast IDentity Online (FIDO) Alliance has promulgated a set of security-focused technologies and protocols intended to simplify and enhance cybersecurity. Information handling systems, such as server devices and/or other computing devices, may benefit by performing authentication via the FIDO Device Onboarding (FDO) protocol, particularly when provided at the “edge” of a network (“edge devices”).

An edge orchestrator or an edge operations software platform may deploy releases that cater to a wide customer base across different industrial domains. These releases may comprise upgrades to control plane, operating systems, or firmware on edge devices. After the release, there may be a need to fix critical issues or to provide a delta change in the delivered feature. These changes are delivered through patch/hotfix releases. Sometimes, the hotfix or patch are customer-specific requirements on a primary feature that are needed to ensure a feature is in alignment with the hardware or software in use on a particular customer's edge devices. Such customizations may not be consumable by another customer's devices.

If an unintended customer uses a fix meant for a specific customer, then the hotfix or patch may trigger issues due to incompatible firmware or hardware on the unintended customer's devices. For example, if a USB hub feature is addressed in a fix requested by Customer A, then that fix might not be a consumable feature for Customer B due to variations in each customer's platform. Moreover, customized changes may require a premium charge for the requesting customer. If successfully consumed by an unintended customer, the unintended customer would get the benefit of the fix at no additional cost. Failure to limit upgrades to intended customers also risks compromising feature confidentiality. Furthermore, fine tuning of operating system, driver, or kernel parameters for a specific customer can have an impact on applications, which may be detrimental if an unintended customer deploys a fix intended for another customer.

Managing hotfixes and patches for a specific customer requirements requires tedious effort by the edge operations platform. Additionally, the effort to ensure that there is no cross-over of upgrade images across customers is a challenge to the development and operations (DevOps) continuous integration and continuous deployment (CI/CD) pipeline. The management of image upgrades calls for a mechanism to ensure that a customer-specific image bundle does not get consumed by an unintended customer.

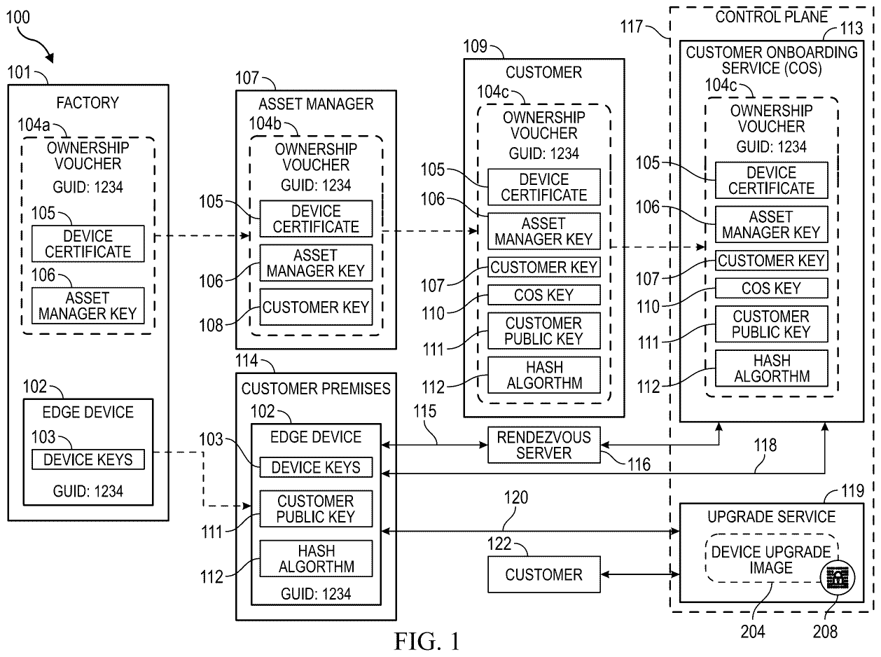

FIG. 1 is a high level block diagram illustrating a process 100 for onboarding a device at a customer location using FDO. A customer orders a device, such as an edge device or end point device, from a manufacturer. The customer provides the edge device requirements and optional details to the manufacturer. These requirements and details are passed on to the manufacturer's factory 101 for further processing. The factory 101 manufactures a device 102 with the customer requirements. During manufacture, the factory 101 executes a FIDO Device Initialization (DI) process and adds various keys 103 to the device 102. The keys 102 may include, for example, a device attestation key, a manufacturing key, and a secret key. Factory 101 also generates an ownership voucher 104a, which may include certain keys and certificates, such as a device certificate 105 and an asset manager key 106. The device 102 has a Globally Unique Identifier (GUID) that can be used to identify a particular item. The ownership voucher 104a can be linked to the device 102 using the GUID.

Ownership voucher 104 makes multiple ownership hops as per the FIDO protocol as it is transferred to the final user of device 101. Ownership voucher 104 changes across the different owners. For example, ownership voucher 104 may be initially transferred to an asset manager 107, which authenticates the voucher using an asset manager manger certificate paired to the asset manager key 106. Asset manager 107 modifies the ownership voucher 104a by adding a customer key 108. The modified ownership voucher 104b is then be transferred to a customer 109 associated with the customer key 108.

Customer 109 authenticates the ownership voucher 104b using a customer certificate paired to the customer key 108. Customer 109 further modifies the ownership voucher 104b by adding a customer onboarding service (COS) key 110. As part of the improvements disclosed herein, customer 109 also updates ownership voucher 104b with a customer public key 111 and a hash generation algorithm 112 to create a modified ownership voucher 104c.

Customer 109 then transfers the ownership voucher 104c to a customer onboarding service 113, which authenticates the ownership voucher 104c using a customer certificate and a COS certificate that are paired to customer key 107 and COS key 110, respectively.

The edge device 102 is shipped from the factory 101 to a customer location 114 where device 102 goes through Power ON and onboarding sequences. As part of the onboarding workflow, device 102 establishes a first network connection 115 with a rendezvous server 116. Device 102 provides the device identifier (GUID) to rendezvous server 116 and receives from the rendezvous server 116 a network address of the onboarding service 113 on the control plane 117. Customer onboarding service 113 is registered with the rendezvous server 116 as an owner of device 102.

Device 102 then establishes a second network connection 118 with the customer onboarding service 113 utilizing the network address received from the rendezvous server 116. Device 102 receives an ownership voucher 104c from customer onboarding service 113 comprising a chain of trust associated with edge device 102. The chain of trust in the ownership voucher 104c may comprise a sequence of digital signatures signed by different entities in a supply chain between a manufacturer of device 102 and the customer/owner of device 102. Device 102 updates a non-volatile memory to indicate successful onboarding in responsive to verifying the chain of trust in the ownership voucher 104c.

Once the ownership voucher verification is successful, the customer public key 111 and the hash generation algorithm 112 that are carried in voucher 104c are stored to a persistent location in device 102.

An upgrade service 119 is also available on the control plane 117. Device 102 can establish a direct connection 120 to upgrade service 119, which allows device 102 to receive one or more device upgrade image. The upgrade service 119 also allows the customer to upgrade device 102 once installed on customer premises 114.

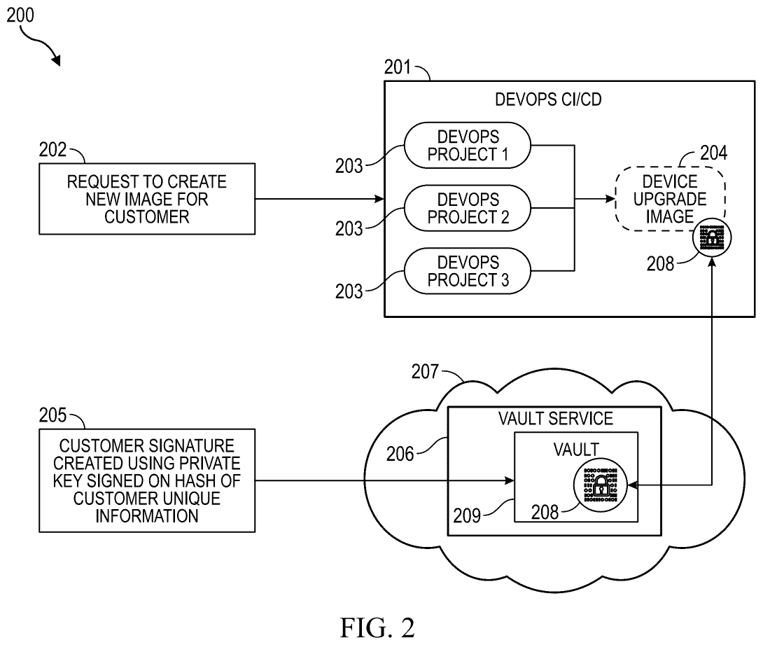

FIG. 2 is a high level block diagram illustrating a process 200 for generating a customer-specific device upgrade image. A development and operations (DevOps) activity has a continuous integration and continuous deployment (CI/CD) pipeline 201 to deliver new versions of software, including patches and hotfixes for problems identified by customers. DevOps receives requests 202 from customers to create a new image for the customer's devices. In response to the customer request 202, one or more DevOps projects 203 result in a device upgrade image 204. Often, the device upgrade image 204 is generated to address specific customer requirements or issues, such as particular configurations, applications, or drivers used by the customer. The distribution and incorporation of the device upgrade image 204 should be limited to the particular customer's devices to ensure confidentiality of the customer's proprietary information and to avoid conflicting upgrades that may result if installed in non-customer devices.

As illustrated in FIG. 2, a customer generates a signature 205 by creating a hash of customer unique information and signing the hash with a customer private key. The customer private key corresponds to customer public key 111 (FIG. 1). The signature 205 is confined to the customer.

The customer uploads the signature 205 and the customer unique information to a vault service 206. The vault service 206 may be hosted on a public or private cloud network 207 that is accessible by the customer and by the DevOps CI/CD pipeline 201. The vault service may be hosted by the same entity that controls DevOps CI/CD 201 or by a third party. The customer signature and the customer unique information is stored as a signature file 208 in a vault 209 on vault service 206.

To ensure that device upgrade image 204 or other hotfix and patch images are limited to customer-specific devices, the DevOps CI/CD pipeline 201 retrieves the signature file 208 with the customer signature and the customer unique information from the vault 209. In some configurations, the signature file 208 is a multi-layered bundle that carries a manufacturer or DevOps signature on top of the customer's signature and the customer unique information. The customer may download the device upgrade image 204 or other customized hotfix or patch image from DevOps CI/CD pipeline 201 in order to update the customer's edge devices.

Referring again to FIG. 1, the customer 122 uploads the device upgrade image 204 with the signature file 208 to control plane 117 and initiates an upgrade for edge device 102. The upgrade service 119 may verify the signature file bundle 208 for the manufacturer signature and then sends the device upgrade image 204 and the signature file 208 to edge device 102.

The edge device 102 extracts the customer unique information and the customer signature from the signature file 208. Edge device 102 stores customer public key 111 and hash generation algorithm 112, which were carried by the ownership voucher 104c and planted on device 102 as part of the onboarding process. Using hash generation algorithm 112, edge device 102 generates a First Hash on the customer unique information. Then, edge device 102 uses the customer public key 111 to decrypt the customer signature to generate a Second Hash. Edge device 102 compares the First Hash and the Second Hash to verify the ownership of device upgrade image as belonging to the current customer. If the First Hash and the Second Hash match, then edge device 102 allows the image upgrade; however, if the First Hash and the Second Hash do not match, then edge device 102 blocks the image upgrade.

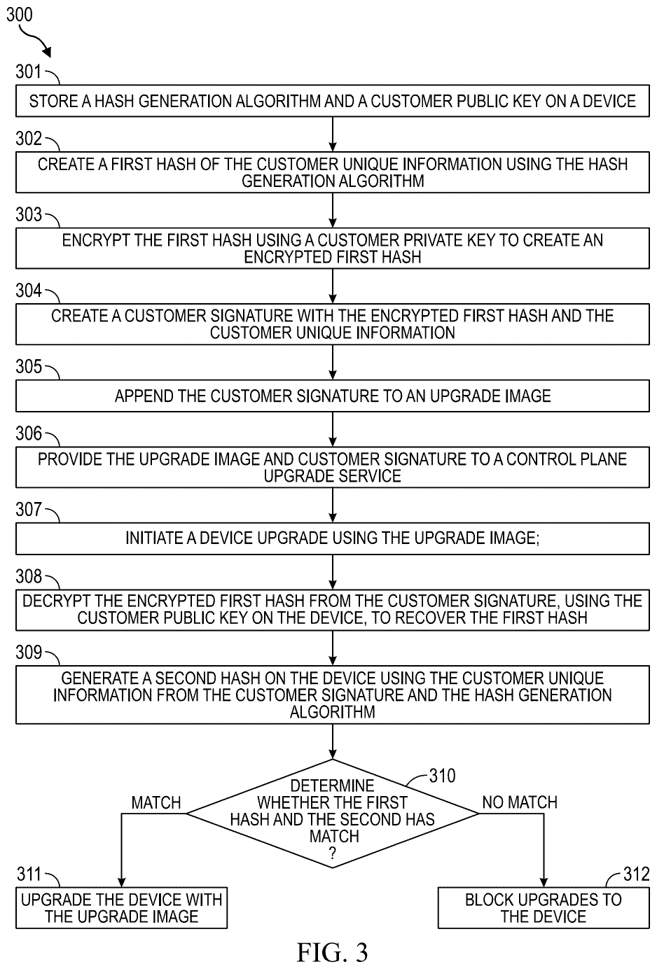

FIG. 3 is flowchart illustrating a process 300 for updating a device, such as an endpoint device or an edge device, using customer-specific upgrade images. In step 301, a hash generation algorithm and a customer public key are stored on a device. The hash generation algorithm and customer public key may be added to the device during an onboarding process and may be carried to the device via an ownership voucher. In step 302, a first hash of customer unique information using the hash generation algorithm. In step 303, the first hash is encrypted using a customer private key to create an encrypted first hash. The customer private key corresponds to the customer public key stored on the device, and the customer public key can be used to decrypt files that are encrypted using the customer private key.

In step 304, a customer signature is created using the encrypted first hash and the customer unique information. In step 305, the customer signature is appended to an upgrade image. In step 306, the upgrade image with the customer signature attached is provided to a control plane upgrade service.

In step 307, a device upgrade is initiated using the upgrade image. In step 308, using the customer public key that was stored on the device at step 301, the encrypted first hash from the customer signature is decrypted to recover the first hash on the device. In step 309, a second hash is generated on the device using the customer unique information from the customer signature and the hash generation algorithm. In step 310, the device determines whether the first hash and the second hash match. If the first hash and the second hash match, then at step 311 the device is upgraded with the upgrade image. On the other hand, if the first hash and the second hash do not match, then at step 312 the device blocks any upgrade using the upgrade image.

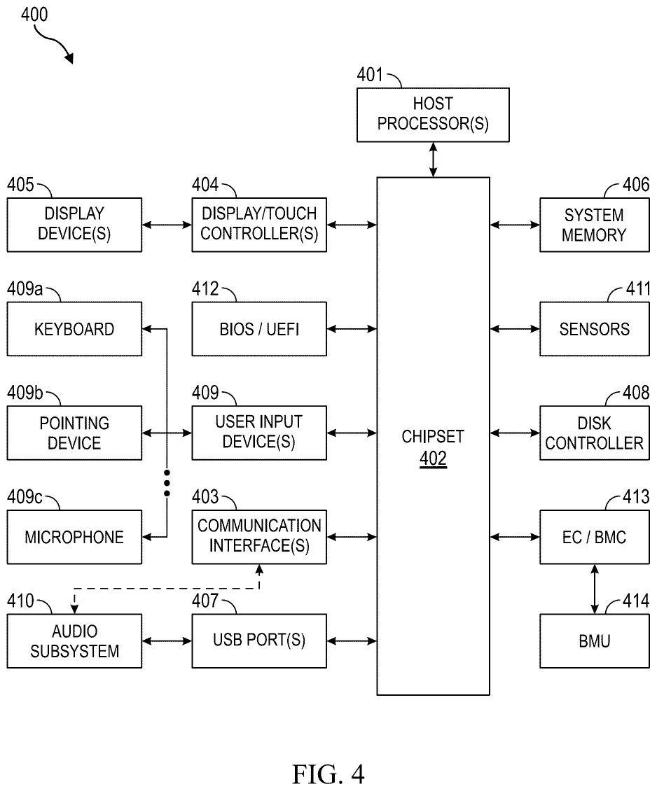

FIG. 4 shows an example of an Information Handling System (IHS) 400 configured to implement systems and methods as described herein for creating FDO-based customer-specific endpoint upgrade images. IHS 400 may be used as an edge device 102 or may host a customer onboarding service 113, rendezvous service 116, upgrade service 119, vault service 209, for example.

As depicted, IHS 400 includes host processor(s) 401. In various embodiments, IHS 400 may be a single-processor system, or a multi-processor system including two or more processors. Host processor(s) 401 may include any processor capable of executing program instructions, such as an INTEL/AMD x76 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 400 includes chipset 402 coupled to host processor(s) 401. Chipset 402 may provide host processor(s) 401 with access to resources. In some cases, chipset 402 may utilize a QuickPath Interconnect (QPI) bus to communicate with host processor(s) 401. Chipset 402 may also be coupled to communication interface(s) 403 to enable communications between IHS 400 and various wired and/or wireless networks, such as Ethernet, WiFi (IEEE 802.11), Bluetooth (IEEE 802.15.1), cellular or mobile networks (e.g., Code-Division Multiple Access or “CDMA,” Time-Division Multiple Access or “TDMA,” Long-Term Evolution or “LTE,” etc.), satellite networks, or the like. Communication interface(s) 403 may be used to communicate with peripheral devices (e.g., Bluetooth speakers, microphones, headsets, etc.). Moreover, communication interface(s) 403 may be coupled to chipset 402 via a Peripheral Component Interconnect Express (PCIe) bus, or the like.

Chipset 402 may be coupled to display and/or touchscreen controller(s) 404, which may include one or more Graphics Processor Units (GPUs) on a graphics bus, such as an Accelerated Graphics Port (AGP) or PCIe bus. As shown, display controller(s) 404 provide video or display signals to one or more display device(s) 405. Display device(s) 405 may include Liquid Crystal Display (LCD), Light Emitting Diode (LED), Organic LED (OLED), or other thin film display technologies. Display device(s) 405 may include a plurality of pixels arranged in a matrix, configured to display visual information, such as text, two-dimensional images, video, three-dimensional images, etc. In some cases, display device(s) 405 may be provided as a single continuous display, rather than two discrete displays.

Chipset 402 may provide host processor(s) 401 and/or display controller(s) 404 with access to system memory 406. In various embodiments, system memory 406 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 402 may also provide host processor(s) 401 with access to one or more Universal Serial Bus (USB) ports/controllers 407, to which one or more peripheral devices may be coupled (e.g., integrated or external webcams, microphones, speakers, etc.).

Chipset 402 may further provide host processor(s) 401 with access to a disk controller 408, which may include a disk interface that connects the disc controller 408 to a Hard Disk Drive (HDD), an Optical Disk Drive (ODD), an SSD, and/or a disk emulator. The disk interface may include, for example, an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. The disk emulator may be provide an external interface that permits one or more hard disk drives, solid-state drives, optical drives, or other removable-media drives to be connected to IHS 400. An example of external interface includes a USB interface, an IEEE 1394 (Firewire) interface, a proprietary interface, or a combination thereof.

Chipset 402 may also provide access to one or more user input devices 409, for example, using a super I/O controller or the like. Examples of user input devices 409 include, but are not limited to, a keyboard 409a, pointing device 409b, such as a mouse, trackball, stylus, or active pen, and/or microphone(s) 409c. Other user input devices 409 (not shown) may include a camera, touchpad, totem, etc. Each user input device 409 may include a respective controller (e.g., a touchpad may have its own touchpad controller) that interfaces with chipset 402 through a wired or wireless connection, for example via communication interfaces(s) 403 and/or USB port(s) 407. Other input devices, such as keyboard 409a, may use a keyboard controller in an operating system.

In some cases, chipset 402 may also provide access to one or more output devices, such as an audio subsystem 410, speakers, headsets, video projectors, paper printers, 3D printers, Virtual/Augmented Reality (VR/AR) devices, etc. The output devices may be accessed, for example, via communication interfaces(s) 403 and/or USB port(s) 407. Audio subsystem 410 may include speakers, which comprise any system, device, or apparatus configured to produce sound in response to electrical audio signal input. In some embodiments, a speaker may comprise a dynamic loudspeaker, which employs a lightweight diaphragm mechanically coupled to a rigid frame via a flexible suspension that constrains a voice coil to move axially through a cylindrical magnetic gap such that when an electrical signal is applied to the voice coil, a magnetic field is created by the electric current in the voice coil, making it a variable electromagnet. The coil and the driver's magnetic system interact, generating a mechanical force that causes the coil (and thus, the attached cone) to move back and forth, thereby reproducing sound under the control of the applied electrical signal coming from the amplifier.

In certain embodiments, chipset 402 may further provide an interface for communications with one or more hardware sensors 411. Sensors 411 may be disposed on or within the chassis of IHS 400, or otherwise coupled to IHS 400, and may include, but are not limited to: electric, magnetic, radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), and/or acceleration sensor(s).

A Basic Input and Output System/Unified Extensible Firmware Interface (BIOS/UEFI) 412 is coupled to chipset 402. UEFI was designed as a successor to BIOS, and many modern IHSs utilize UEFI in addition to or instead of a BIOS. Accordingly, BIOS/UEFI 412 is intended to also encompass a UEFI component. BIOS/UEFI 412 provides an abstraction layer that allows the OS to interface with certain hardware components that are utilized by IHS 400. Upon booting of IHS 400, host processor(s) 401 may utilize program instructions of BIOS 412 to initialize and test hardware components coupled to IHS 400, and to load a host OS for use by IHS 400. Via the hardware abstraction layer provided by BIOS/UEFI 412, software stored in system memory 406 and executed by host processor(s) 401 can interface with I/O devices coupled to IHS 400.

An Embedded Controller (EC) 413 (sometimes referred to as a Baseboard Management Controller or “BMC”) includes a microcontroller unit or processing core dedicated to handling selected IHS operations not ordinarily handled by host processor(s) 401. Examples of such operations may include, but are not limited to: power sequencing, power management, receiving and processing signals from a keyboard or touchpad, as well as other buttons and switches (e.g., power button, laptop lid switch, etc.), receiving and processing thermal measurements (e.g., performing cooling fan control, throttling CPUs and GPUs, controlling colling fan speeds, and emergency shutdown), controlling indicator Light-Emitting Diodes (LEDs) (e.g., caps lock, scroll lock, num lock, battery, ac, power, wireless LAN, sleep, etc.), managing the battery charger and the battery, enabling remote or Out-of-Band (OOB) management, diagnostics, and remediation over network(s), and the like.

Unlike other devices in IHS 400, EC 413 may be made operational from the very start of each power reset, before other devices are fully running or powered on. As such, EC 413 may be responsible for interfacing with a power adapter to manage the power consumption of IHS 400. These operations may be utilized to determine the power status of IHS 400, such as whether IHS 400 is operating from battery power or is plugged into an AC power source. Firmware instructions utilized by EC 413 may be used to manage other core operations of IHS 400 (e.g., turbo modes, maximum operating clock frequencies of certain components, etc.).

In some cases, EC 413 may implement operations for detecting certain changes to the physical configuration or posture of IHS 400 and managing other devices in different configurations of IHS 400. For instance, when IHS 400 as a 2-in-1 laptop/tablet form factor, EC 413 may receive inputs from a lid position or hinge angle sensor 411, and it may use those inputs to determine: whether the two sides of IHS 400 have been latched together to a closed position or a tablet position, the magnitude of a hinge or lid angle, etc. In response to these changes, the EC may enable or disable certain features of IHS 400 (e.g., front or rear facing camera, etc.).

In some implementations, EC 413 may be installed as a Trusted Execution Environment (TEE) component to the motherboard of IHS 400. Additionally, or alternatively, EC 413 may be further configured to calculate hashes or signatures that uniquely identify individual components of IHS 400. In such scenarios, EC 413 may calculate a hash value based on the configuration of a hardware and/or software component coupled to IHS 400. For instance, EC 413 may calculate a hash value based on all firmware and other code or settings stored in an onboard memory of a hardware component.

In addition, EC 413 may provide an Out-of-Band communication channel that allows an Information Technology Decision Maker (ITDM) or Original Equipment Manufacturer (OEM) to manage IHS 400's various settings and configurations, for example, by issuing OOB commands.

In various embodiments, IHS 400 may be coupled to an external power source through an AC adapter, power brick, or the like. The AC adapter may be removably coupled to a battery charge controller to provide IHS 400 with a source of DC power provided by battery cells of a battery system in the form of a battery pack (e.g., a lithium ion or “Li-ion” battery pack, or a nickel metal hydride or “NiMH” battery pack including one or more rechargeable batteries). Battery Management Unit (BMU) 414 may be coupled to EC 413 and it may include, for example, an Analog Front End (AFE), storage (e.g., non-volatile memory), and a microcontroller. In some cases, BMU 414 may be configured to collect and store information, and to provide that information to other IHS components.

Examples of information collectible by BMU 414 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information or state (e.g., such as ambient temperature, relative humidity, system geolocation measured by GPS or triangulation, time and date, etc.), events, etc. Examples of events may include, but are not limited to: acceleration or shock events, system transportation events, exposure to elevated temperature for extended time periods, high discharge current rate, combinations of battery voltage, battery current and/or battery temperature (e.g., elevated temperature event at full charge and/or high voltage causes more battery degradation than lower voltage), etc.

In some embodiments, IHS 400 may not include all the components shown in FIG. 4. Furthermore, some components that are represented as separate components in FIG. 4 may instead be integrated with other components, such that all or a portion of the operations executed by the illustrated components may instead be executed by the integrated component. For example, in various embodiments described herein, host processor(s) 401 and/or other components shown in FIG. 4 (e.g., chipset 402, display controller(s) 404, communication interface(s) 403, EC 413, etc.) may be replaced by other devices. As such, IHS 400 may assume different form factors including, but not limited to: servers, workstations, desktops, laptops, appliances, video game consoles, tablet computers, smartphones, etc.

In an example configuration, an endpoint device comprises a processor and a memory coupled to the processor. The memory having program instructions stored thereon that, upon execution, cause the processor to: receive an upgrade image having a customer signature wherein the customer signature comprises an encrypted first hash and customer unique information, recover a first hash by decrypting the encrypted first hash using a customer public key stored on the endpoint device, generate a second hash using the customer unique information and a hash generation algorithm stored on the endpoint device, determine whether the first hash and the second hash match; and if the first hash and the second hash match, then allow a device upgrade using the upgrade image, or if the first hash and the second hash do not match, then block a device upgrade using the upgrade image.

The program instructions on the endpoint device may further cause the processor to: execute a Fast IDentity Online (FIDO) device onboarding process with a control plane on installation of the device. The program instructions on the endpoint device may further cause the processor to: receive the customer public key and the hash generation algorithm from the control plane during the FIDO device onboarding process. The control plane may receive the customer public key and the hash generation algorithm from an ownership voucher associated with the endpoint device. The upgrade image may comprise updates to an operating system, kernel parameters, driver, or firmware on the endpoint device. The encrypted first hash may be created using a customer private key, wherein the customer public key can be used to decrypt files that are encrypted using the customer private key. The first hash may be created by a customer remote from the endpoint device using the hash generation algorithm on the customer unique information.

In an example embodiment, a method comprises the steps of storing a hash generation algorithm on a device, storing a customer public key on the device, creating a first hash of customer unique information using the hash generation algorithm, encrypting the first hash using a customer private key to create an encrypted first hash, wherein the customer public key can be used to decrypt files that are encrypted using the customer private key, creating a customer signature comprising the encrypted first hash and the customer unique information, appending the customer signature to an upgrade image, providing the upgrade image and customer signature to a control plane upgrade service, initiating a device upgrade using the upgrade image, decrypting the encrypted first hash from the customer signature, using the customer public key on the device, to recover the first hash, generating a second hash on the device using the customer unique information from the customer signature and the hash generation algorithm, determining whether the first hash and the second hash match, and if the first hash and the second hash match, then upgrade the device with the upgrade image, or if the first hash and the second hash do not match, then block the upgrade image from upgrading the device.

The hash generation algorithm and the customer public key used in the method may be stored on the device during an onboarding process when the device is first deployed. The onboarding process may be a Fast IDentity Online (FIDO) device onboarding process.

The method may further comprise transferring the hash generation algorithm and the customer public key from an ownership voucher to the device.

The upgrade image used in the method may be configured to upgrade a particular customer's endpoint devices.

The upgrade image used in the method is created and the customer signature is appended by a DevOps CI/CD pipeline.

The may further comprise storing, by a customer, the customer signature to a cloud-based vault service and retrieving, by the DevOps CI/CD pipeline, the customer signature from the cloud-based vault service to be appended to the upgrade image.

An example system for creating and verifying customer-specific endpoint upgrade images comprises: a control plane onboarding service configured to execute a Fast IDentity Online (FIDO) device onboarding process, wherein the control plane provides a customer public encryption key and a hash generation algorithm to an endpoint device during the onboarding process; a control plane upgrade service configured to provide upgrade images to the onboarded endpoint device, the upgrade image having an embedded customer signature, wherein the customer signature comprises an encrypted first hash and customer-specific information; and the endpoint device comprising a processor and a memory coupled to the processor. The memory having program instructions stored thereon that, upon execution, cause the processor to: receive the upgrade image from the control plane; recover a first hash by decrypting the encrypted first hash using the customer public encryption key; generate a second hash using the customer-specific information and the hash generation algorithm; determine whether the first hash and the second hash match; update the endpoint device using the upgrade image if the first hash and the second hash match; and block the endpoint device upgrade if the first hash and the second hash do not match.

The control plane onboarding service may be further configured to transfer the customer public encryption key and the hash generation algorithm from an ownership voucher to the endpoint device during the onboarding process.

The upgrade image may comprise updates to an operating system, kernel parameters, driver, or firmware on the endpoint device.

The encrypted first hash may be created using a customer private key, and the customer public encryption key is used to decrypt files that are encrypted using the customer private key.

The customer-specific information may include a unique identifier associated with the customer.

A DevOps CI/CD pipeline may be configured to append a manufacturer signature on top of the customer signature in the upgrade image.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. An endpoint device, comprising:
a processor; and
a memory coupled to the processor, the memory having program instructions stored thereon that, upon execution, cause the processor to:
receive an upgrade image having a customer signature, wherein the customer signature comprises an encrypted first hash and customer unique information;
recover a first hash by decrypting the encrypted first hash using a customer public key stored on the endpoint device;
generate a second hash using the customer unique information and a hash generation algorithm stored on the endpoint device;
determine whether the first hash and the second hash match;
if the first hash and the second hash match, then allow a device upgrade using the upgrade image; and
if the first hash and the second hash do not match, then block a device upgrade using the upgrade image.

2. The endpoint device of claim 1, wherein the program instructions further cause the processor to:
execute a Fast IDentity Online (FIDO) device onboarding process with a control plane on installation of the device.

3. The endpoint device of claim 2, wherein the program instructions further cause the processor to:
receive the customer public key and the hash generation algorithm from the control plane during the FIDO device onboarding process.

4. The endpoint device of claim 3, wherein the control plane receives the customer public key and the hash generation algorithm from an ownership voucher associated with the endpoint device.

5. The endpoint device of claim 1, wherein the upgrade image comprises updates to an operating system, kernel parameters, driver, or firmware on the endpoint device.

6. The endpoint device of claim 1, wherein the encrypted first hash is created using a customer private key, wherein the customer public key can be used to decrypt files that are encrypted using the customer private key.

7. The endpoint device of claim 1, wherein the first hash is created by a customer remote from the endpoint device using the hash generation algorithm on the customer unique information.

8. A method, comprising:
store a hash generation algorithm on a device;
store a customer public key on the device;
using the hash generation algorithm, create a first hash of customer unique information;
encrypt the first hash using a customer private key to create an encrypted first hash, wherein the customer public key can be used to decrypt files that are encrypted using the customer private key;
create a customer signature comprising the encrypted first hash and the customer unique information;
append the customer signature to an upgrade image;
provide the upgrade image and customer signature to a control plane upgrade service;
initiate a device upgrade using the upgrade image;
decrypt the encrypted first hash from the customer signature, using the customer public key on the device, to recover the first hash;
generate a second hash on the device using the customer unique information from the customer signature and the hash generation algorithm;
determine whether the first hash and the second hash match;
if the first hash and the second hash match, then upgrade the device with the upgrade image; and
if the first hash and the second hash do not match, then block the upgrade image from upgrading the device.

9. The method of claim 8, wherein the hash generation algorithm and the customer public key are stored on the device during an onboarding process when the device is first deployed.

10. The method of claim 9, wherein the onboarding process is a Fast IDentity Online (FIDO) device onboarding process.

11. The method of claim 8, further comprising:
transfer the hash generation algorithm and the customer public key from an ownership voucher to the device.

12. The method of claim 8, wherein the upgrade image is configured to upgrade a particular customer's endpoint devices.

13. The method of claim 8, wherein the upgrade image is created and the customer signature is appended by a DevOps CI/CD pipeline.

14. The method of claim 13, further comprising:
storing, by a customer, the customer signature to a cloud-based vault service; and
retrieving, by the DevOps CI/CD pipeline, the customer signature from the cloud-based vault service to be appended to the upgrade image.

15. A system for creating and verifying customer-specific endpoint upgrade images, comprising:
a control plane onboarding service configured to execute a Fast IDentity Online (FIDO) device onboarding process, wherein the control plane provides a customer public encryption key and a hash generation algorithm to an endpoint device during the onboarding process;
a control plane upgrade service configured to provide upgrade images to the onboarded endpoint device, the upgrade image having an embedded customer signature, wherein the customer signature comprises an encrypted first hash and customer-specific information; and
the endpoint device comprising a processor and a memory coupled to the processor, the memory having program instructions stored thereon that, upon execution, cause the processor to:
receive the upgrade image from the control plane;
recover a first hash by decrypting the encrypted first hash using the customer public encryption key;
generate a second hash using the customer-specific information and the hash generation algorithm;
determine whether the first hash and the second hash match;
update the endpoint device using the upgrade image if the first hash and the second hash match; and
block the endpoint device upgrade if the first hash and the second hash do not match.

16. The system of claim 15, wherein the control plane onboarding service is further configured to transfer the customer public encryption key and the hash generation algorithm from an ownership voucher to the endpoint device during the onboarding process.

17. The system of claim 15, wherein the upgrade image comprises updates to an operating system, kernel parameters, driver, or firmware on the endpoint device.

18. The system of claim 15, wherein the encrypted first hash is created using a customer private key, and the customer public encryption key is used to decrypt files that are encrypted using the customer private key.

19. The system of claim 15, wherein the customer-specific information includes a unique identifier associated with the customer.

20. The system of claim 15, wherein a DevOps CI/CD pipeline is configured to append a manufacturer signature on top of the customer signature in the upgrade image.
